(19) United States
(12) Patent Application Publication
(10) Pub. No.: US 2023/0189049 A1
(43) Pub. Date: Jun. 15, 2023

(54) MANAGING A WIRELESS DEVICE THAT IS OPERABLE TO CONNECT TO A COMMUNICATION NETWORK

(71) Applicant: Telefonaktiebolaget LM Ericsson (publ), Stockholm (SE)

(72) Inventors: Pablo Soldati, Solna (SE); Henrik Rydén, Stockholm (SE)

(21) Appl. No.: 18/016,009

(22) PCT Filed: Jul. 9, 2021
(86) PCT No.: PCT/EP2021/069163

§ 371 Date: Jan. 13, 2023

Related U.S. Application Data
(60) Provisional application No. 63/050,907, filed on Jul. 13, 2020.

(51) Int. Cl. H04W 28/02; H04W 8/22

(52) U.S. Cl. CPC H04W 28/0231; H04W 8/22

(57) ABSTRACT

A method is disclosed for managing a wireless device that is operable to connect to a communication network. The communication network comprises a Radio Access Network (RAN), and the method is performed by a RAN node of the communication network. The method comprises receiving, from the wireless device, information indicating whether the wireless device is capable of executing a Machine Learning (ML) model that is operable to provide an output on the basis of which at least one RAN operation performed by the wireless device may be configured.

### TECHNICAL FIELD

The present disclosure relates to methods for managing a wireless device that is operable to connect to a communication network, the methods performed by a Radio Access Network (RAN) node of the communication network, and by the wireless device. The present disclosure also relates to a RAN node for managing a wireless device that is operable to connect to a communication network, a wireless device, and to a computer program product configured, when run on a computer to carry out methods for managing a wireless device.

### BACKGROUND

Machine Learning (ML) is a branch of Artificial Intelligence (AI), and refers to the use of algorithms and statistical models to perform a task. ML generally involves a training phase, in which algorithms build a computational operation based on some sample input data, and an inference phase, in which the computational operation is used to make predictions or decisions without being explicitly programmed to perform the task. Support for ML in communication networks is an ongoing challenge. The 3^{rd} Generation Partnership Project (3GPP) has proposed a study item on “Radio Access Network (RAN) intelligence (Artificial Intelligence/Machine Learning) applicability and associated use cases (e.g. energy efficiency, RAN optimization), which is enabled by Data Collection”. It is proposed that the study item will investigate how different use cases impact the overall AI framework, including how data is stored across the different network nodes, model deployment, and model supervision. It is anticipated that use of AI will be a key component in future generations of communication networks, including 6^{th} and 7^{th} generation networks. How to deploy such intelligence across a RAN and its connected wireless devices is an open question.

Integrating the use of ML models into existing operational procedures involves several challenges, and there is currently no framework within 3GPP to support the use, at wireless devices, of ML models in the context of RAN operations.

### SUMMARY

It is an aim of the present disclosure to provide methods, a RAN node, a wireless device and a computer readable medium which at least partially address one or more of the challenges mentioned above. It is a further aim of the present disclosure to provide methods, a RAN node, a wireless device and a computer readable medium which cooperate to facilitate the use, by the wireless device, of an ML model in the context of a RAN operation that may be performed by the wireless device.

According to a first aspect of the present disclosure, there is provided a method for managing a wireless device that is operable to connect to a communication network, wherein the communication network comprises a Radio Access Network (RAN). The method, performed by a RAN node of the communication network, comprises receiving, from the wireless device, information indicating whether the wireless device is capable of executing a Machine Learning (ML) model that is operable to provide an output on the basis of which at least one RAN operation performed by the wireless device may be configured.

According to another aspect of the present disclosure, there is provided another method for managing a wireless device that is operable to connect to a communication network, wherein the communication network comprises a RAN. The method, performed by the wireless device, comprises sending, to a RAN node of the communication network, information indicating whether the wireless device is capable of executing an ML model that is operable to provide an output on the basis of which at least one RAN operation performed by the wireless device may be configured.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node of a communication network comprising a RAN, wherein the RAN node is for managing a wireless device that is operable to connect to the communication network. The RAN node comprises processing circuitry configured to cause the RAN node to receive, from the wireless device, information indicating whether the wireless device is capable of executing an ML model that is operable to provide an output on the basis of which at least one RAN operation performed by the wireless device may be configured.

According to another aspect of the present disclosure, there is provided a wireless device that is operable to connect to a communication network, wherein the communication network comprises a RAN. The wireless device comprises processing circuitry configured to cause the wireless device to send, to a RAN node of the communication network, information indicating whether the wireless device is capable of executing an ML model that is operable to provide an output on the basis of which at least one RAN operation performed by the wireless device may be configured.

Aspects of the present disclosure thus provide a framework for supporting the provision to a RAN by a wireless device of information relating to the use and/or execution of ML models, including algorithms, at the wireless device. Such information may inform subsequent management of the wireless device, configuration and execution of its ML models, configuration of RAN operations performed by the wireless device, processing of reports provided by the wireless device, etc.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a RAN node for managing a wireless device;

FIGS. 2a to 2c show a flow chart illustrating process steps in another example of a method performed by a RAN node for managing a wireless device;

FIG. 3 is a flow chart illustrating process steps in a method performed by a wireless device for managing the wireless device;

FIGS. 4a and 4b show a flow chart illustrating process steps in another example of a method performed by a wireless device for managing the wireless device;

FIG. 5 illustrates an example autoencoder r for CSI compression;

FIG. 6 illustrates an overview of use of an ML model to encode/decode wireless signals directly;

FIG. 7 is a signalling diagram illustrating an example signalling exchange;

FIG. 8 is a signalling diagram illustrating another example signalling exchange;

FIG. 9 is a block diagram illustrating functional modules in a RAN node;

FIG. 10 is a block diagram illustrating functional modules in another example of a RAN node;

FIG. 11 is a block diagram illustrating functional modules in a wireless device; and

FIG. 12 is a block diagram illustrating functional modules in another example of a wireless device.

### DETAILED DESCRIPTION

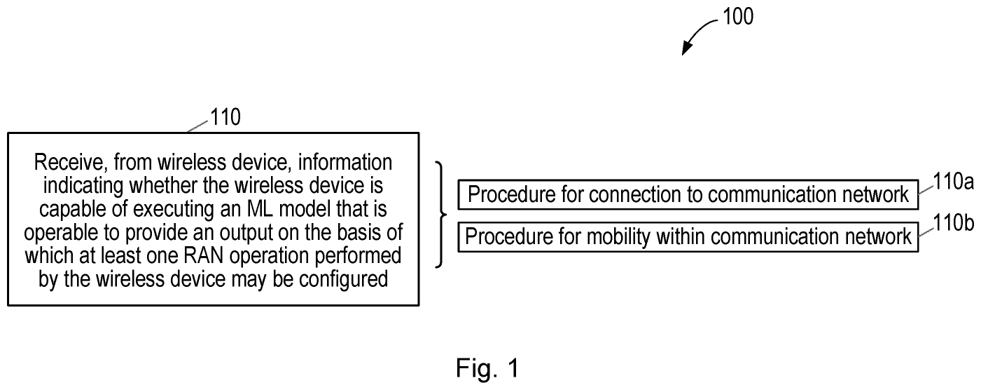

FIG. 1 is a flow chart illustrating process steps in a method 100 for managing a wireless device that is operable to connect to a communication network, wherein the communication network comprises a Radio Access Network (RAN). The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a base station node such as a NodeB, eNodeB, gNodeB, or any future implementation of the above discussion functionality. Referring to FIG. 1, the method 100 comprises, in step 110, receiving, from the wireless device, information indicating whether the wireless device is capable of executing a Machine Learning (ML) model that is operable to provide an output on the basis of which at least one RAN operation performed by the wireless device may be configured. As illustrated at 110a and 110b, the information may be received at step 110 during a procedure performed by the wireless device for at least one of connection to the communication network and/or mobility within the communication network. The mobility within the communication network may relate to mobility between locations in the network, and consequent Handover between service areas such as cells, or to mobility between serving nodes for other reasons, for example as part of random access, Radio Resource Control (RRC) connection setup, handover, tracking area change, Load Balancing, multi-connectivity such as Dual Connectivity, etc.

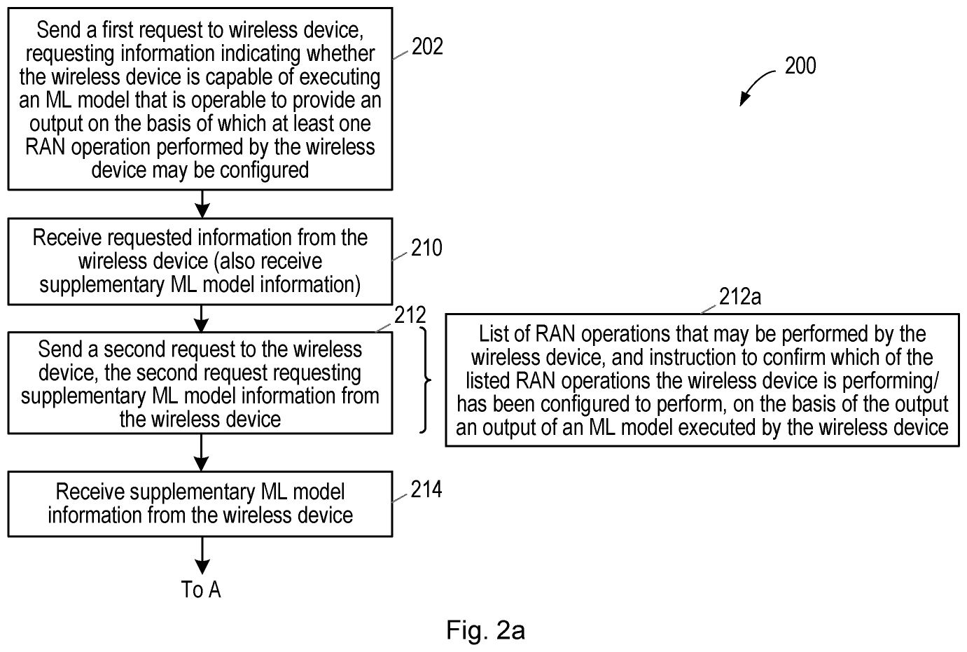

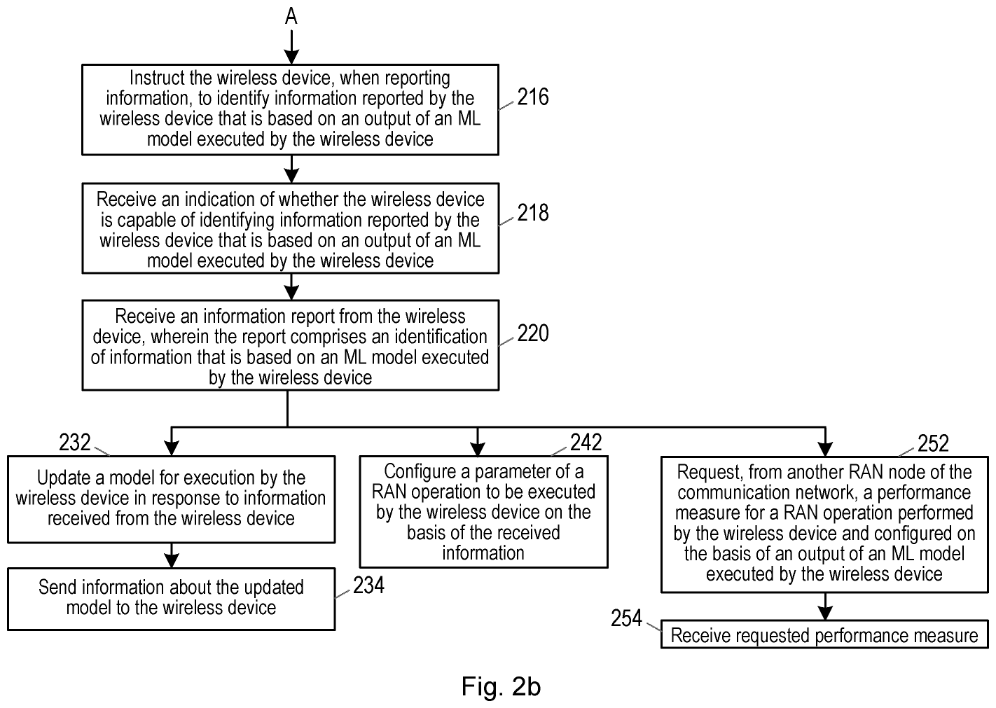

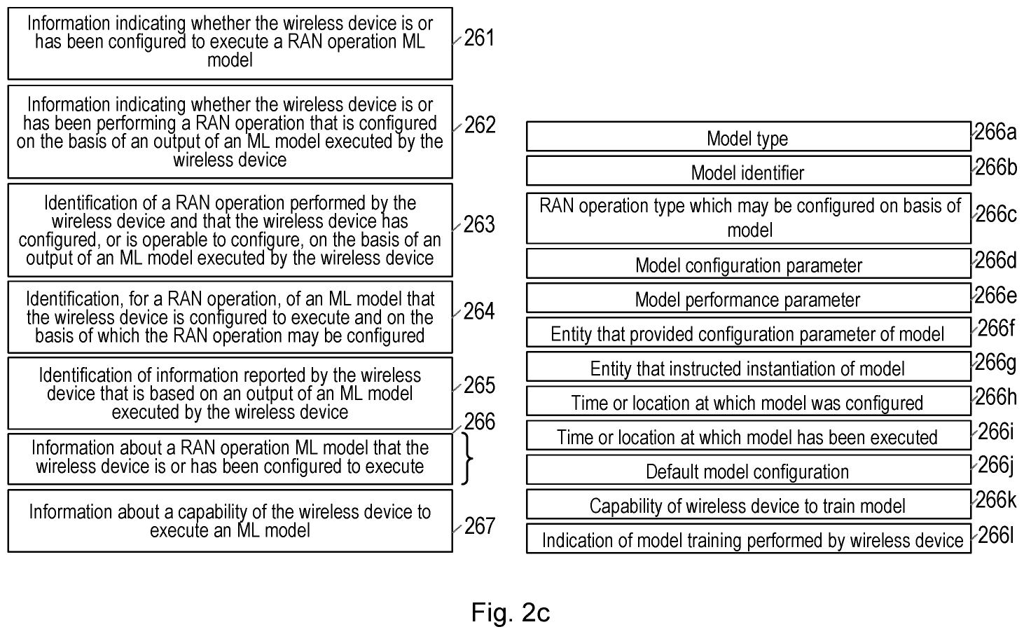

The information received in step 110 may indicate the capability of the wireless device in a variety of different ways, depending upon a particular implementation or use case. In some examples, the indication of capability may be provided as a single bit of information, for example a flag that is set of the wireless device has the capability, and not set if the wireless device does not have the capability. In other examples, the information may include additional detail regarding the capability of the wireless device. In still further examples, the indication of capability may be implicit, though the inclusion in the information of detail about use or configuration of ML models at the wireless device. Different options for the information that may be conveyed to serve as an indication of capability, or to supplement the indication with additional detail, are discussed in detail below with reference to FIGS. 2a to 2c and various example use cases and implementations.

The RAN operation performed by the wireless device, which operation may be configured on the basis of an output of the ML model, may be configured by the wireless device itself or by a node of the communication network, which may be the RAN node performing the method 100. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include Handover, secondary carrier prediction, geolocation, signal quality prediction, beam measurement and beamforming, traffic prediction, Uplink synchronisation, channel state information compression, wireless signal reception/transmission, etc. Any one of more of these example operations or operation types may be configured on the basis of an output of an ML model. For example, the ML model may predict certain measurements, on the basis of which decisions for RAN operations may be taken. Such measurements may be used by the wireless device and/or provided to the RAN node performing the method 100. In further examples, the timing or triggering of a RAN operation may be based upon a prediction output by an ML model.

In some examples of the method 100, as discussed in further detail below, the method 100 may further comprise requesting the information received from the wireless device, and may further comprise receiving supplementary ML model information from the wireless device, the supplementary ML model information including a range of elements relating to the configuration and/or execution of ML models at the wireless device. In still further examples of the method 100, the method may further comprise instructing the wireless device, when reporting information, to identify information reported by the wireless device that is based on an output of an ML model executed by the wireless device. In this manner, the RAN node may then distinguish between reported information that is based on measurements, and reported information that is based on an output of an ML model.

FIGS. 2a to 2c show a flow chart illustrating process steps in another example of method 200 for managing a wireless device that is operable to connect to a communication network, wherein the communication network comprises a RAN. The method 200 may enable management of more than one wireless device. The method 200 provides various examples of how the steps of the method 100 may be implemented and supplemented to achieve the above discussed and additional functionality. As for the method 100, the method 200 is performed by a RAN node of the communication network, which may comprise a physical node and/or a virtualised network function, as discussed above.

Referring first to FIG. 2a, in a first step 202, the RAN node sends a first request to the wireless device, the first request requesting information indicating whether the wireless device is capable of executing an ML model that is operable to provide an output on the basis of which at least one RAN operation performed by the wireless device may be configured. In some examples, a second request requesting supplementary ML model information from the wireless device may be sent with the first request, for example in the same message. The first and second requests may be sent during a Handover procedure. In one example, the first and second requests are sent in a PDCCHs (physical downlink control channels) in NR/LTE. For example, the first request, and second request if present, may be included as Information Elements in a RRCReconfiguration message, that is used to modify or setup an RRC connection to the UE. In other examples, the first and second request messages may be sent as dedicated messages for the purpose of sending the first and second requests. The dedicated massages could be sent in the Physical Downlink Shared Channel (PDSCH) data channels defined in NR/LTE.

In step 210, the RAN node receives, from the wireless device, the requested information indicating whether the wireless device is capable of executing an ML model that is operable to provide an output on the basis of which at least one RAN operation performed by the wireless device may be configured. As illustrated, this information may be received in response to the first request, and/or may be provided by the wireless device without prompting via the first request. The requested information may be received by the RAN node in a dedicated message, for example via the Physical Uplink Shared Channel (PUSCH) in LTE/NR. In other examples, sending the requested information in any of the physical uplink control channels (PUCCHs) defined LTE/NR. For example including the information as one or more Information Elements in a message sent as part of a connection or mobility procedure performed by the wireless device, for example including the requested information in the RRCReconfiguration complete message, which is used to confirm the successful completion of an RRCReconfiguration.

As illustrated at step 210, the RAN node may also receive, at step 210 and in response to the first request, supplementary ML model information from the wireless device. Supplementary ML model information is discussed in further detail below with reference to FIG. 2c.

In step 212, the RAN node may send a second request to the wireless device, the second request requesting supplementary ML model information from the wireless device. Examples of supplementary ML model information are discussed below with reference to FIG. 2c. One such example is an identification of a RAN operation performed by the wireless device and that the wireless device has configured, or is operable to configure, on the basis of an output of an ML model executed by the wireless device. The second request that may be sent at step 212 may therefore comprise, as illustrated at 212a, a list of RAN operations that may be performed by the wireless device, and an instruction to confirm which of the listed RAN operations the wireless device is performing, or has been configured to perform, on the basis of an output of an ML model executed by the wireless device. The list of RAN operations could for example be provided as a bitmap, with each bit of the bitmap corresponding to a RAN operation, and a wireless device instructed to update the bitmap in order to convey the requested confirmation.

In step 214, the RAN node may receive the requested supplementary ML model information from the wireless device, in response to the second request. The supplementary ML model information may be provided by the wireless device in a dedicated message, or as Information Elements in a message exchanged as part of a RAN procedure performed by the wireless device. It will be appreciated that the wireless device may provide the supplementary ML model information in response to the first request from the RAN node, the second request from the RAN node, or without specific instruction from the RAN node via requests. For example, the wireless device may provide the supplementary ML model information as part of a connection or mobility procedure performed by the wireless device.

Referring now to FIG. 2b, the RAN node, in step 216, may instruct the wireless device, when reporting information, to identify information reported by the wireless device that is based on an output of an ML model executed by the wireless device. The instructed identification may be at different levels of granularity, for example the identification may be at the level of a report message, indicating that the message contains one or more items of information that are based on an output of an ML model. In other examples, the identification may be at the level of individual items of reported information, identifying specific information items that are based on an output of an ML model. Information based on an output of an ML model may comprise the output of the ML model, for example if the ML model outputs a predicted value of a measurement, or may comprise a derivative of a model output, a selection or decision taken on the basis of a model output, etc. The instruction to identify reported information that is based on an output of an ML model may be sent in a control message and/or the instruction may be included with the first and/or second requests sent at step 202 and/or 212.

In response to the instruction sent at step 216, the RAN node may receive an indication of whether the wireless device is capable of identifying information reported by the wireless device that is based on an output of an ML model executed by the wireless device. The RAN node may consequently correctly interpret an absence of an indication of ML based information in future reports received from the wireless device. The RAN node may further receive, in step 220, an information report from the wireless device, wherein the report comprises an identification of information that is based on an ML model executed by the wireless device. The report may be any report that is specified as part of current or future generation communication network procedures, or is provided by the wireless device on an ad hoc basis specific to a particular deployment or use case. In some examples, legacy reports may be augmented to include an indication of ML based information items. Examples of reports that may include an identification of ML based information and be received at step 220 include reports associated with radio resource management, wireless device measurement, mobility operations, random access operation, multi-connectivity operation, beamforming operations, RRC state handling, traffic control, energy efficiency operations, etc.

Steps 232 to 254 illustrate different actions that may be taken by the RAN node, in accordance with the method 200, as a consequence of the information received at step 210 and/or step 214. As illustrated at step 232, the RAN node may update a model for execution by the wireless device in response to information received from the wireless device, and may send information about the updated model to the wireless device in step 234. In some examples, the updating of a model at step 232 may be performed on the basis of the received information, which may be combined with other information available to the first RAN node, including changes in the radio network environment since the model was last configured or executed, changes in the network including new RAN nodes, etc. The model may also be updated for example to take account of a capability of the wireless device. Sending information about the updated model may comprise sending a complete updated model, sending only updates to the model, sending information about when the updated model should be used, etc.

In step 242, the RAN node may configure a parameter of a RAN operation to be executed by the wireless device on the basis of the received information. For example, if the information received from the wireless device indicates that the wireless device has a suitable model for predicting signal strength of beams, the RAN node may configure a parameter of a beamforming management operation so as to transmit fewer beams to the wireless device, the wireless device being able to predict signal strength on the non-transmitted beams. In another example, if the information received from the wireless device indicates that the wireless device has a suitable model for predicting coverage on a target carrier, the RAN node may configure a parameter relating to the frequency of source carrier signalling for the wireless device, reducing the frequency of source carrier signalling to the wireless device. Other examples of configuration of RAN operation parameters on the basis of the received information may be envisaged.

In step 252, the RAN node may request, from another RAN node of the communication network, a performance measure for a RAN operation performed by the wireless device and configured on the basis of an output of an ML model executed by the wireless device. The other RAN node may be a previous serving node for the wireless device. Further detail of such request and receipt of information from another network node is discussed in a non-published reference document.

It will be appreciated that the steps of the method 200 may be performed in a different order to that presented above, and may be interspersed with actions executed as part of other procedures being performed concurrently by the RAN node. For example, multiple reports indicating the presence of ML information may be provided by the wireless device in response to the instruction sent at step 216. Such reports may be spaced over a period of time during which the wireless device is served by the RAN node. The reports may have content and be provided at times that are standardised as part of current or future generation communication networks.

FIG. 2c illustrates examples of information items that may be included in the supplementary ML model information received by the RAN node at step 210 and/or 214. Referring to FIG. 2c, steps 261 to 267 illustrate examples of information that may be included in the supplementary ML model information that is received by the RAN node. According to different examples of the present disclosure, the supplementary ML model information may include any combination of one, some, all or none of the information illustrated at 261 to 267. Each example of information is discussed in greater detail below.

The supplementary ML model information may comprise information 261 indicating whether the wireless device is or has been configured to execute an ML model that is operable to provide an output on the basis of which at least one RAN operation performed by the wireless device may be configured. The supplementary ML model information may further comprise information 262 indicating whether the wireless device is or has been performing a RAN operation that is configured on the basis of an output of an ML model executed by the wireless device, and/or an identification 263 of a RAN operation performed by the wireless device and that the wireless device has been configured, or is operable to configure, on the basis of an output of an ML model executed by the wireless device.

In some examples, the supplementary ML model information may comprise an identification 264, for a RAN operation, of an ML model that the wireless device is configured to execute and on the basis of which the RAN operation may be configured. The supplementary ML model information may additionally or alternatively comprise an identification 265 of information reported by the wireless device that is based on an output of an ML model executed by the wireless device.

In some examples, the supplementary ML model information may comprise information 266 about an ML model that the wireless device is or has been configured to execute, wherein the ML model is operable to provide an output on the basis of which at least one RAN operation performed by the wireless device may be configured. In further examples, the supplementary ML model information may comprise information 267 about a capability of the wireless device to execute an ML model.

The information 266 about an ML model that the wireless device is or has been configured to execute may encompass a wide range of information items, as illustrated in FIG. 2c. The information 266 about an ML model that the wireless device is or has been configured to execute may comprise any one or more of the following:
a model type 266a;
a model identifier 266b;
a RAN operation type which may be configured on the basis of an output of the model 266c;
a model configuration parameter 266d;
a model performance parameter 266e;
identification of an entity that provided a configuration parameter for the model 266f;
identification of an entity that instructed instantiation of the model 266g;
a time or location in which the model was configured 266h;
a time or location in which the model has been executed by the wireless device 266i;
a default configuration of the model 266j;
a capability of the wireless device to train the model 266k;
an indication of training of the model performed by the wireless device 266l.

It will be appreciated that in the above list, and in the rest of the present disclosure, the use of “a” or “an” does not exclude a plurality, thus the information 266 about an ML model that the wireless device is or has been configured to execute may comprise one or more model configuration parameters, one or more model performance parameters, etc.

The information 267 about a capability of the wireless device to execute an ML model may comprise any one or more of the following:
Wireless device manufacturer/model etc.
Maximum consumed memory of model that can be supported.
Floating point support, for example 8-bit/16-bit/32-bit float.
Wireless device computational capabilities, for example in terms of number of operations per second, type of processor (CPU, GPU), number of CPUs etc. This could be reported specifically for executing an ML model or more generally associated to the wireless device.
Type of models supported, for example decision tree, decision forest, linear regression, feedforward neural network, recurrent neural network, convolutional neural network, etc.
Maximum supported computational cost/load for executing a model. This could be expressed, for example, in terms of a number of operations and their type that the wireless device can perform for executing a model. The maximum supported computational cost/load can also be associated to a particular type of model. Therefore, for each model supported by the UE, the UE could report a maximum supported computational cost for executing a model. This may enable a RAN node to select the most appropriate model (type, dimension, etc.) for a specific UE based on the UE capabilities.

In some examples, the capabilities may include an indication about the number of different ML models with which the wireless device can be configured simultaneously. For example, the wireless device could indicate that it can be configured with at most three decision trees and two Neural Networks simultaneously, or with 4 Neural Networks simultaneously etc. This capability may be based on the wireless device's hardware and software limitations.

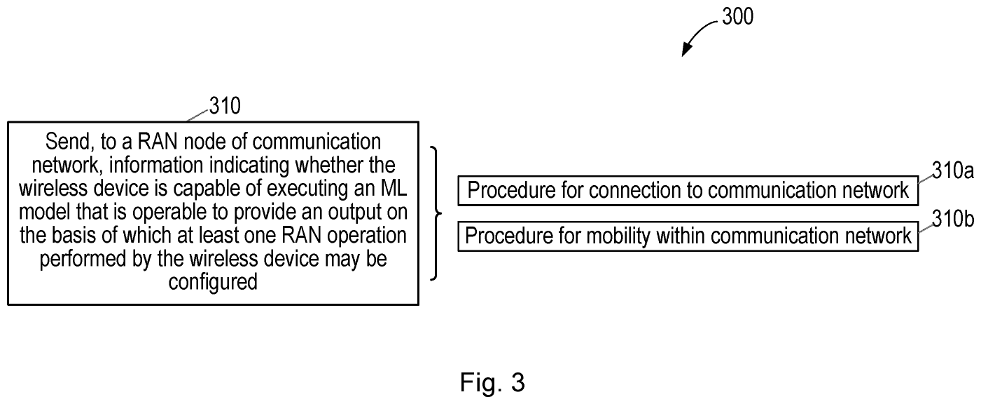

The methods 100 and/or 200 may be complemented by a method 300 performed by a wireless device. FIG. 3 is a flow chart illustrating process steps in a method 300 for managing a wireless device that is operable to connect to a communication network, wherein the communication network comprises a RAN. The method 300 is performed by the wireless device. Referring to FIG. 3, the method 300 comprises, in a first step 310, sending, to a RAN node of the communication network, information indicating whether the wireless device is capable of executing an ML model that is operable to provide an output on the basis of which at least one RAN operation performed by the wireless device may be configured. As illustrated at 310a and 310b, the information may be sent at step 310 during a procedure performed by the wireless device for at least one of connection to the communication network and/or mobility within the communication network. The mobility within the communication network may relate to mobility between locations in the network, and consequent Handover between service areas such as cells, or to mobility between serving nodes for other reasons, for example as part of random access, Radio Resource Control (RRC) connection setup, handover, tracking area change, Load Balancing, multi-connectivity such as Dual Connectivity, etc. The information sent in step 310 may indicate the capability of the wireless device in a variety of different ways, depending upon a particular implementation or use case. Further detail of what may be included in the information is discussed above, with reference to FIGS. 1 and 2a to 2c, and below.

As discussed above, the RAN operation performed by the wireless device may be configured on the basis of an output of the ML model by the wireless device itself or by a node of the communication network, which may be the RAN node from which the configuration information was received. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations are discussed above in the context of the method 100, and below in relation to use case and implementation examples for the methods discussed herein.

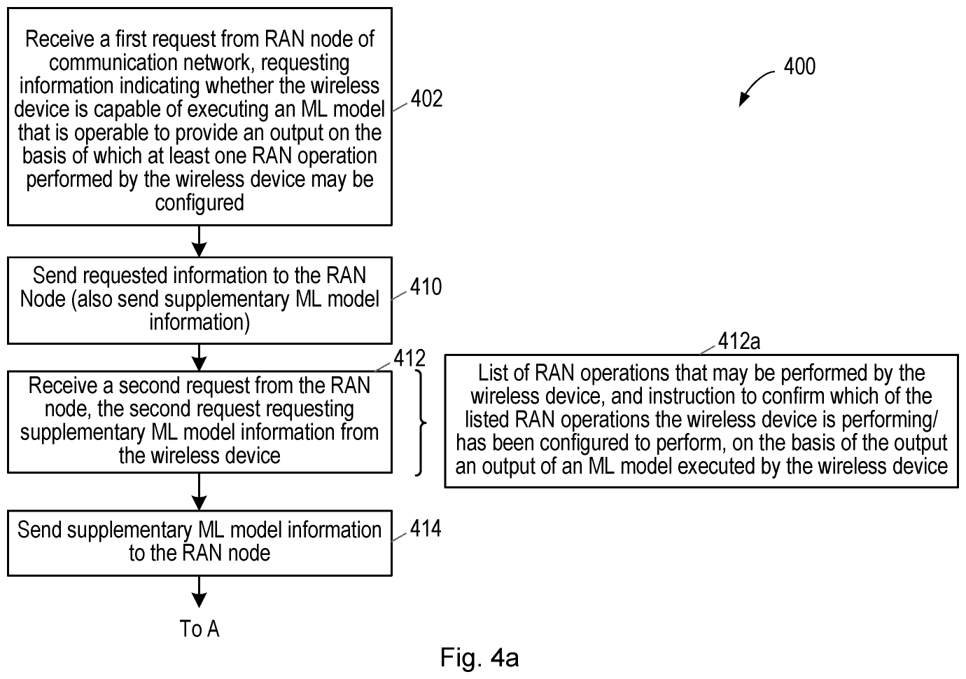

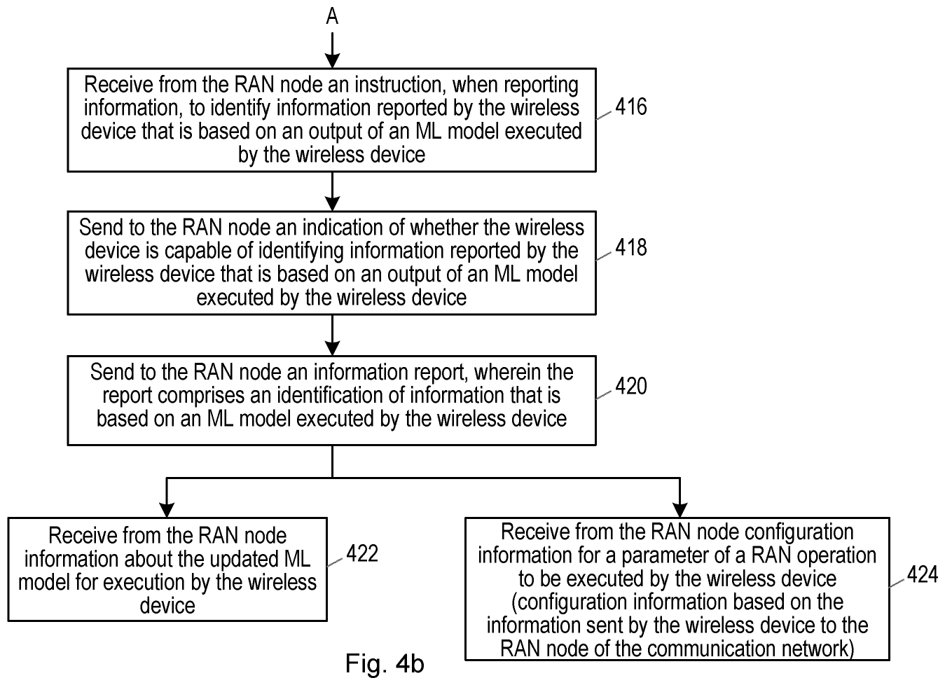

FIGS. 4a to 4c show a flow chart illustrating process steps in another example of method 400 for managing a wireless device that is operable to connect to a communication network, wherein the communication network comprises a RAN. The method 400 provides various examples of how the steps of the method 300 may be implemented and supplemented to achieve the above discussed and additional functionality. The method 400 is performed by the wireless device.

Referring first to FIG. 4a, the wireless device may first, in step 402, receive a first request from the RAN node of the communication network, the first request requesting information indicating whether the wireless device is capable of executing an ML model that is operable to provide an output on the basis of which at least one RAN operation performed by the wireless device may be configured. In some examples, a second request requesting supplementary ML model information from the wireless device may be received with the first request, for example in the same message. In one example, the first and second requests are sent in a PDCCHs (physical downlink control channels) in NR/LTE. For example, the first request, and second request if present, may be included as Information Elements in a RRCReconfiguration message, that is used to modify or setup an RRC connection to the UE. In other examples, the first and second request messages may be sent as dedicated messages for the purpose of sending the first and second requests. The dedicated massages could be sent in the Physical Downlink Shared Channel (PDSCH) data channels defined in NR/LTE.

In step 410, the wireless device sends, to the RAN node, the requested information indicating whether the wireless device is capable of executing an ML model that is operable to provide an output on the basis of which at least one RAN operation performed by the wireless device may be configured. As illustrated, this information may be sent in response to the first request, and/or may be provided by the wireless device without prompting via the first request. The requested information may be sent by the wireless device in a dedicated message, for example via the Physical Uplink Shared Channel (PUSCH) in LTE/NR. In other examples, sending the requested information in any of the physical uplink control channels (PUCCHs) defined LTE/NR. For example including the information as one or more Information Elements in a message sent as part of a connection or mobility procedure performed by the wireless device, for example including the requested information in the RRCReconfiguration complete message, which is used to confirm the successful completion of an RRCReconfiguration.

As illustrated at step 410, the wireless device may also send, at step 410 and in response to the first request, supplementary ML model information for the wireless device. Supplementary ML model information is discussed in detail above with reference to FIG. 2c.

In step 412, the wireless device may receive a second request from the RAN node of the communication network, the second request requesting supplementary ML model information from the wireless device. Examples of supplementary ML model information are discussed above with reference to FIG. 2c, and this discussion is not repeated here. One example of supplementary ML model information is an identification of a RAN operation performed by the wireless device and that the wireless device has configured, or is operable to configure, on the basis of an output of an ML model executed by the wireless device. The second request that may be received at step 412 may therefore comprise, as illustrated at 412a, a list of RAN operations that may be performed by the wireless device, and an instruction to confirm which of the listed RAN operations the wireless device is performing, or has been configured to perform, on the basis of an output of an ML model executed by the wireless device. The list of RAN operations could for example be provided as a bitmap, with each bit of the bitmap corresponding to a RAN operation, and the wireless device instructed to update the bitmap in order to convey the requested confirmation.

In step 414, the wireless device may send to the RAN node of the communication network the requested supplementary ML model information. The supplementary ML model information may be sent by the wireless device in a dedicated message, or as Information Elements in a message exchanged as part of a RAN procedure performed by the wireless device. It will be appreciated that the wireless device may provide the supplementary ML model information in response to the first request from the RAN node, the second request from the RAN node, or without specific instruction from the RAN node via requests. For example, the wireless device may send the supplementary ML model information as part of a connection or mobility procedure performed by the wireless device.

Referring now to FIG. 4b, the wireless device, in step 416, may receive from the RAN node of the communication network an instruction, when reporting information, to identify information reported by the wireless device that is based on an output of an ML model executed by the wireless device. As discussed above with reference to the method 200, the instructed identification may be at different levels of granularity, for example the identification may be at the level of a report message, indicating that the message contains one or more items of information that are based on an output of an ML model. In other examples, the identification may be at the level of individual items of reported information, identifying specific information items that are based on an output of an ML model. Information based on an output of an ML model may comprise an output of the ML model, for example if the ML model outputs a predicted value of a measurement, or may comprise a derivative of a model output, a selection or decision taken on the basis of a model output, etc. The instruction to identify reported information that is based on an output of an ML model may be received in a control message and/or the instruction may be included with the first and/or second requests received at step 402 and/or 412.

In response to the instruction received at step 416, the wireless device may send in step 418 an indication of whether the wireless device is capable of identifying information reported by the wireless device that is based on an output of an ML model executed by the wireless device. The wireless device may further send, in step 420, an information report to the RAN node of the communication network, wherein the report comprises an identification of information that is based on an ML model executed by the wireless device. The report may be any report that is specified as part of current or future generation communication network procedures, or is provided by the wireless device on an ad hoc basis specific to a particular deployment or use case. In some examples, legacy reports may be augmented to include an indication of ML based information items. Examples of reports that may include an identification of ML based information and be sent at step 420 include reports associated with radio resource management, wireless device measurement, mobility operations, random access operation, multi-connectivity operation, beamforming operations, RRC state handling, traffic control, energy efficiency operations, etc.

The wireless device may then perform either or both of steps 422 and/or 424, according to actions taken by the RAN node in response to the information sent by the wireless device. In step 422, the wireless device may receive, from the RAN node of the communication network, information about the updated ML model for execution by the wireless device. In step 424, the wireless device may receive, from the RAN node, configuration information for a parameter of a RAN operation to be executed by the wireless device wherein the configuration information is based on the information sent by the wireless device to the RAN node of the communication network.

It will be appreciated that, as for the method 200 discussed above, the steps of the method 400 may be performed in a different order to that presented above, and may be interspersed with actions executed as part of other procedures being performed concurrently by the wireless device. For example, multiple reports indicating the presence of ML information may be sent by the wireless device in response to the instruction received at step 416. Such reports may be spaced over a period of time during which the wireless device is served by the RAN node. The reports may have content and be provided at times that are standardised as part of current or future generation communication networks.

The methods 100, 200, 300 and 400 illustrate how a RAN node and wireless device may cooperate to support the implementation and orchestration of ML models executed by a wireless device in support of RAN operations. A RAN node may request information from a wireless device related to the use and execution of ML models at the device, or the wireless device may provide this information without having been explicitly requested to do so. In addition, examples of the present disclosure enable a RAN node to distinguish between reported information that is based on an ML model output, and reported information that is based on direct radio measurements or other information sources, so informing subsequent operational decisions and/or further processing which may use or be guided by the reported information. Providing information about use and execution of ML models at wireless devices, as well as identifying reported information based on such models, may facilitate network optimisation as well as wireless device configuration, so improving the system performance and optimising interoperability across network equipment of different kinds and from different vendors.

Example methods according to the present discourse may also offer adaptability, supporting dynamic management of ML models to reflect changes in the radio environment (deployment of new base station(s), sleeping cells, new antenna(s), tilt-change(s), sleeping cells, etc.), which can render configured models invalid. This type of change in radio environment information might not be detected by the device, and aspects of the present disclosure may thus ensure that a wireless device does not use a model that has been trained for an outdated radio-environment. Additionally, examples of the present disclosure may facilitate coordination in situations in which a model is trained both by a RAN node and by a wireless device, such as may be the case for example for traffic prediction models. Ensuring a complete understanding of ML model configuration at a wireless device can assist in ensuring efficient exploitation of ML capabilities, and consequently in improving performance of network operations.

The ML models of that are the subject of the present disclosure are models that are operable to provide an output on the basis of which a RAN operation performed by a wireless device may be configured. Examples of RAN operations performed by a wireless device that could be executed in accordance with an output of an ML model according to the present disclosure are presented below. The following discussion divides the example RAN operations into those which are both trained and executed by the wireless device (referred to in the following discussion as a User Equipment or UE), and those which are trained by a node of the communication network of which the RAN is a part, and subsequently downloaded to a wireless device for execution.

### ML Model Trained and Executed by UE

Some AI/ML capable UEs are able to build intelligence that can be used to improve the radio network operation, as in the following examples:

### Example 1: Lower Latency Via Traffic Prediction

In delay critical applications it is important not to lose Uplink synchronisation immediately before or during arrival of data, as synchronising the Uplink prior to Uplink transmission increases delay. One solution to this issue is to force a UE to perform synchronisation if no Uplink transmission has taken place within a certain time window. However, this can lead to a large increase of signalling and interference related to unnecessary uplink synchronisation. A UE could instead predict data arrival using an ML model, and consequently ensure that Uplink synchronisation is completed before the predicted data arrival. The traffic experienced by one UE can be used to train a model that predicts when synchronisation, or in general when Uplink resources may be required. A UE could for example send a scheduling request if traffic is expected based on executed ML model, and so reduce its latency. In such examples, the RAN operation that may be configured on the basis of an output of the ML model would be Uplink synchronisation, and its configuration would be the timing of the synchronisation, to coordinate with traffic predictions provided by the model.

### Example 2: Mobility Prediction

UEs typically move along similar trajectories each day, representing daily or weekly movement patterns of users. Instead of measuring signal strengths of neighbouring cells, a UE could therefore use its geo-location an input to predict the signal strength of a particular reference signal (for example the 5^{th} generation 3GPP Synchronisation Signal Block (SSB) for a radio base station). The predicted signal strength can then be used to trigger different events, such as a handover decision. In this example, the RAN operation that may be configured on the basis of an output of the ML model would be handover, and its configuration would be the timing of the handover decision, on the basis of predicted signal strength from the ML model.

### Example 3: Beam Management

A UE may use an ML model to reduce its measurement requirements related to beamforming. In the RAN of a 5^{th} Generation 3GPP network, referred to as New Radio (NR), it is possible to request a wireless device such as a UE to perform measurements on a set of Channel State Information Reference Signal (CSI-RS) beams. A stationary UE may experience a static environment and consequently minimal change in beam quality. The UE can therefore save battery by reducing beam measurements: using an ML model to predict beam strength instead of measuring it. A UE may for example measure a subset of beams and use an ML model to predict measurements for remaining beams.

### ML Model Trained by Communication Network and Signalled to UE for Execution

As mentioned in a non-published reference document, several use cases may benefit from training an ML model at the communication network, and then signalling the model to a wireless device for execution.

### Example 4: Secondary Carrier Prediction

In order to detect a node on another frequency using target carrier prediction, a UE is required to perform signalling of source carrier information. For example a mobile UE may periodically transmit source carrier information in order to enable a macro node to handover the UE to another node operating at a higher frequency. Using target carrier prediction, the UE would not need to perform inter-frequency measurements, leading to energy savings at the UE. Frequent signalling of source carrier information that would enable predicting the secondary frequency can lead to an additional overhead and should thus be minimized. However, there is a risk that if frequent periodic signalling is not performed, an opportunity for inter-frequency handover to a less-loaded cell on another carrier may be missed. For example, if the reporting periodicity is too high, the UE may not report any source carrier measurement when inside the coverage region of a less loaded cell. According to examples of the present disclosure, the UE could be configured with an ML model, and use source carrier information as input to the model, which then triggers an output indicating coverage on the less loaded cell. This reduces the need for frequent source carrier information signalling, while enabling the UE to predict the coverage on the target cell.

### Example 5: Privacy-Conserving Use of Geo-Location

UE location may be used to predict conditions on possible alternative network nodes that the UE could connect to. In the case of an ML model that is trained at the network, the necessary transfer of data may give rise to privacy concerns, and federated learning may therefore be used, as discussed in a non-published reference document.

### Example 6: Signal Quality Drop Prediction

Based on received UE data from measurement reports, the network can learn for example what sequences of signal quality measurements (e.g. the Reference Signal Received Power, RSRP) result in a large signal quality drop, for example when turning around a corner. This can be done by dividing a periodically reported UE RSRP measurement on reference signals into a training and prediction window. Predicted future signal quality values can be used to: initiate an inter-frequency handover; set handover and/or reselection parameters; and/or change the UE scheduler priority, for example scheduling the second UE at a time when the expected signal quality is good.

### Example 7: Compression of Channel State Information (CSI)

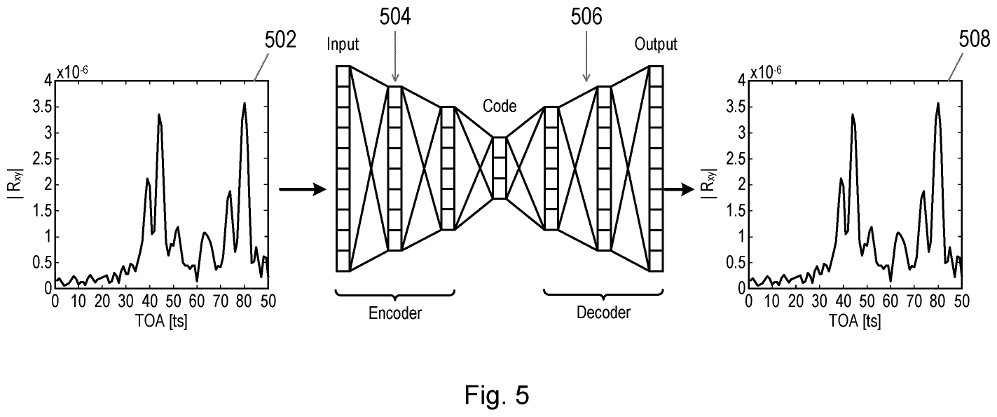

It has been proposed in a non-published reference document to use Autoencoders to compress CSI for enhanced beamforming. An autoencoder is a type of machine learning algorithm that may be used to learn efficient data representations, that is to concentrate data. Autoencoders are trained to take a set of input features and reduce the dimensionality of the input features, with minimal information loss. An autoencoder is divided into two parts, an encoding part or encoder and a decoding part or decoder. The encoder and decoder may comprise, for example, deep neural networks comprising layers of neurons. An encoder successfully encodes or compresses the data if the decoder is able to restore the original data stream with a tolerable loss of data. One example of an autoencoder comprising an encoder/decoder for CSI compression is illustrated in FIG. 5. At the UE, the measured absolute values of the Channel Impulse Response (CIR) are input to the encoder part to be compressed to a code. This code is reported to a radio network node, which uses a corresponding decoder part of the autoencoder to reconstruct the measured CIR. The radio node may then perform beamforming based on the decoded code (CIR).

In a further proposal, the methods described above may be developed for compressing a channel in order to improve the Observed Time Difference of Arrival (OTDOA) positioning accuracy in a multipath environment. OTDOA is one of the positioning methods introduced for Long Term Evolution (LTE) networks in 3GPP specification Release 9. The richer channel information provided by OTDOA can enable the network to test multiple hypotheses for position estimation at the network side, which increases the potential for a more accurate position estimation. For channel compression, the encoder part of the autoencoder, once rained at the network, is signalled for execution to the UE.

### Example 8: Encoding/Decoding of Wireless Signals

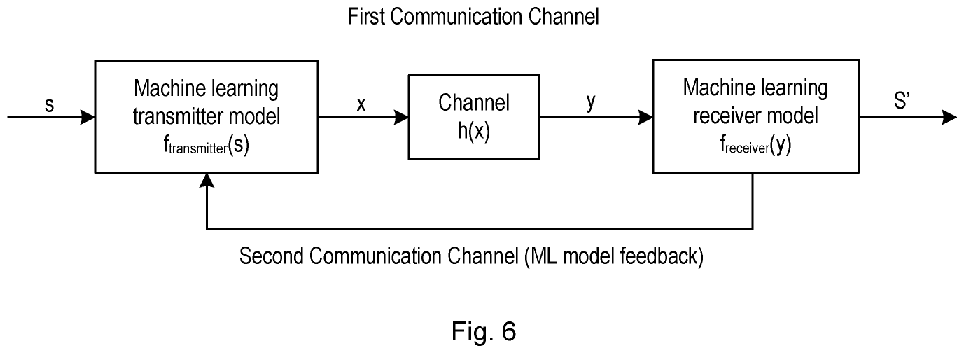

In future generations of wireless networks, it is anticipated that an ML model may be used to encode/decode wireless signals directly. This is in contrast to existing systems, such as 5^{th} generation NR, in which steps in the receiver chain including source decoder, channel decoder and de-modulator (analog to digital) are specified. The existing building blocks for the receiver chain, or parts of the existing building blocks, could be replaced with an ML model. This replacement would allow joint optimisation, enabling sharing of information across different layers, and so achieving higher flexibility and reducing the handcrafted design of each block. The high-level overview of such procedure is illustrated in FIG. 6.

Referring to FIG. 6, a wireless device can receive from a radio network node a receiver model detailing how to process a received wireless signal y, or a transmitter model detailing how to generate a wireless signal x, in order to transmit the device's data symbols s. Feedback in the form of information on the ML model performance can be signalled via a second communication channel, such as NR RRC protocol, or LTE, or Wifi. This feedback can be used to improve the ML model. The model or models can be sent to the device over the same second communication channel. In this example (e.g. using NR SIB/RRC), the first communication channel is used to transmit data to the device, while the second communication channel provides the control information (for example the models used in the first communication channel).

The above examples demonstrate some of the use cases in which ML models may support RAN operations, and consequently in which methods according to examples of the present disclosure may support the implementation and orchestration of ML models to optimise such RAN operations.

There now follows a discussion of a range of different implementation detail that may be encompassed within the methods disclosed herein. The detail presented below encompasses how the information exchanged according to the above methods may be incorporated into existing signalling protocols, examples of the specific information that may be exchanged, and further discussion of example use cases and deployment scenarios for the methods of the present disclosure.

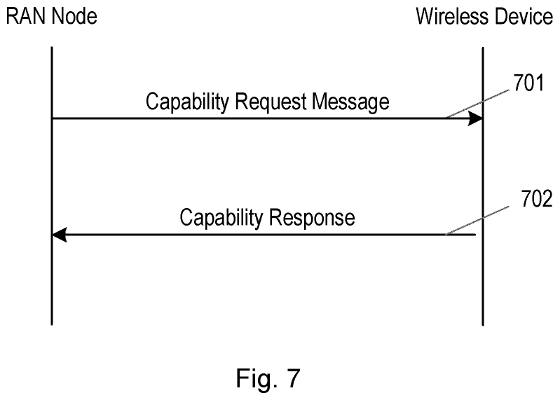

FIG. 7 is a signalling diagram illustrating an example signalling exchange that may take place during the performance of the methods 100, 200, 300 and/or 400. Referring to FIG. 7, first step 701, a RAN node transmits a request message to at least one wireless device requesting to report whether the user device is capable or configured to use ML models. In step 702, the RAN node receives from the wireless device a response message. The message may indicate whether the wireless device is either capable or configured to use, or is using, ML models for its operation.

The message exchange of FIG. 7 may enable the RAN node to gather information, from wireless devices within the coverage area of its controlled radio cells, about the capability of those wireless devices to use machine learning models and algorithms to execute operations related to wireless device activity within the radio network. In particular, the message exchange enables the RAN node to evaluate the behaviour of the wireless device, so as to optimise and configure resources and radio parameters for the wireless device. For example, the network node may distinguish between wireless devices that report information based on radio measurements and wireless devices that report information based on the result of ML models for operations related to the wireless device activity within the radio network, such as coverage estimation, signal strength measurement reports, mobility reports, etc.

In one example, the wireless device response message received in step 702 may comprise either of:
A positive acknowledgment (ACK) indicating that the wireless device is either capable or configured to use (or is using) ML models and algorithms for its operation; or
A negative acknowledgement (NACK) indicating that the wireless device either is not capable or not configured to use (or is not using) machine learning models and algorithms for its operation.

The wireless device response message may additionally comprise a report indicating which operations the wireless device executes based on ML models/algorithms. This report may in some examples not be directly triggered by the network node. For example, it may be implicitly or explicitly stated, for example via a 3GPP specification, that a wireless device should include which radio operations the wireless device executes using ML models/algorithms when the device connects to the network (random access, RRC connection setup), or at handover, or when its tracking area changes.

In some examples, the RAN node may trigger or instruct the wireless device to report which radio operations the wireless device is capable of executing based on a ML model/algorithm. In one implementation, the request message 701 may include a request to report to the network node which radio operations the wireless device currently executes with ML models/algorithms. In another implementation, the RAN node may transmit a separate signal to request the wireless device to report to the RAN node which radio operations the wireless device executes with ML models/algorithms. This could be achieved, for example, by signalling from the RAN node to the wireless device a list of one or more radio operations performed by the wireless device for which it is requested to indicate whether the wireless device executes a machine learning model or algorithm.

Examples of operations executed by the wireless device with a machine learning model may comprise one or more operations in the group of:
power control in Uplink (UL) transmission
Link adaptation in UL transmission, such as selection of modulation and coding scheme
Estimation of channel quality or other performance metrics, such as
   radio channel estimation in uplink and downlink,
   channel quality indicator (CQI) estimation/selection,
   signal to noise estimation for uplink and downlink,
   signal to noise and interference estimation,
   reference signal received power (RSRP) estimation,
   reference signal received quality (RSRQ) estimation, etc.
Information compression for UL transmission
Coverage estimation for secondary carrier
Estimation of signal quality/strength degradation
Mobility related operations, such as cell reselection and handover trigger
Energy saving operations

In response to a request received from a RAN node instructing the wireless device to report to the RAN node which radio operations the wireless device executes with ML models/algorithms, the wireless device indicates to the network node which operations the wireless device executes based on a ML model/algorithm. In one example, this could be implemented using a bitmap, wherein each bit corresponds to an element of the operations list of the request message, with a value set to 1 if the wireless device executes the corresponding operation (or a part of the operation) based on an ML model or algorithm, and set to zero otherwise. The wireless device may transmit this information as part of the response message 702 or in a separate message.

As discussed above, the RAN node may additionally instruct the wireless device to identify in report messages information that is based on executed ML models. For example, the RAN node may transmit a control message to a wireless device comprising an instruction for the wireless device to indicate, within at least a report message transmitted by the wireless device, whether and which information comprised in the report is generated or determined by an ML model or algorithm. The RAN node may then receive from the wireless device either a positive acknowledgement (ACK) or a negative acknowledgement (NACK) associated to the control message. A positive acknowledgement indicates that the wireless device can report the requested information, and a negative acknowledgement indicates that the wireless device cannot report the requested information to the network node. In the case of a positive acknowledgement, or if no acknowledgement is sent, the RAN node may further receive from the wireless device at least a report associated to one or more operations of the wireless device comprising an indication of whether and which information comprised in the report is generated or determined by a ML model or algorithm. In some examples, the instruction to identify ML generated or determined information in a report may be included with the request message 701.

In one example, the RAN node may configure the wireless device to indicate whether and which information elements of legacy reports comprise information generated with a ML model or algorithm. Examples of reports which may be augmented with this information include reports associated with:
Radio resource management
Wireless device measurement
Mobility operations, (e.g., handover reports, link failure reports, etc.)
Random access operation (e.g., RACH reports)
Dual or multi-connectivity operation
Beamforming operations
RRC state handling
Traffic control
Energy efficiency operations

As discussed above, the RAN node may additionally instruct the wireless device to report information associated to the ML model/algorithms that can be used for one or more specific operations. The RAN node may for example transmit to the wireless device a request/instruction to indicate information associated to the machine learning models and algorithms used by the wireless device for one or more operations executed by the wireless device. The RAN node may additionally receive, from the wireless device, the requested information associated to the machine learning models and algorithms used by the wireless device for one or more operation executed by the wireless device.

As for the previously discussed instruction relating to reported information, the request to indicate information about ML algorithms may be included within the request message 701 transmitted by the network node, or may be transmitted in a separate message. The request may be associated with specific operations executed by the wireless device that are of interest for the network node. As such, the message may comprise an indication of which operation of the wireless device the request or instruction applies to. Examples of information associated to the machine learning models and algorithms used by the wireless device that may be sent by the wireless device to the RAN node may include:
The type of ML model or algorithm used by the wireless device;
A unique identifier of the model, which may be used by the RAN node to derive information on when, where and how the model was generated. The model-ID could also indicate the operator or network vendor that generated the model.
The type of networking operation served by the ML model or algorithm
Information associated to the ML model or algorithm configuration parameters, and/or how and when the parameters were configured.
Measured or estimated ML model/algorithm performance, for instance in terms of accuracy or precision. This could be represented with average values over a certain interval of time, standard deviation, maximum or minimum value, etc.
Information about which network node or radio cell has instantiated, configured or modified the configuration and use of the ML model/algorithm for the wireless device, such as the cell ID, the type of cell, the type of transmission model used in the cell, etc.
Information about when the model was instantiated
Information about when and in what radio cells the model has been used
Information about the default configuration of the ML model and algorithm used by the wireless device
Information about which network operator has instantiated, configured or modified the configuration of the ML model/algorithm.
An indication of whether the wireless device has training capability
An indication of whether and/or when the wireless device has trained, retrained or updated a machine learning model. In this case, the information associated with the machine learning models used by the wireless device may further include information associated with training.
An indication of when and in what radio-nodes the wireless device has previously used an ML model

In light of the information provided by the wireless device, the RAN node may take a range of different actions and/or decisions related to management and configuration of the wireless device within the radio access network. These actions may include performing model updates, configuring radio network parameters, requesting a performance measure from a node that previously served the wireless device, etc.

### Performing Model Updates

The received model information can be combined with information about changes in the radio environment, such as a base station, new antenna-tilt settings, new bandwidth, new frequencies, sleeping cells configurations etc., in order to identify whether or not the model is still valid for the current environment. If the radio environment has changed since the model was last trained or configured, it may be outdated, and consequently prediction performance will be degraded. The network can update the model based on the above information, and send an updated model to the UE. The network can also build and signal a new model if the performance measure associated with an existing model is below a threshold value.

### Configuring Radio Network Parameters

The network can use the information provided by the wireless device to inform configuration of radio network parameters for the wireless device. For example, in a beamforming use case (example 3 above), the network can reduce the number of transmitted beams to the UE, as the UE can use its model to predict the non-transmitted beams. In privacy-conserving use of geo-location (example 5 above), a UE capable of predicting coverage on another carrier can be requested to signal inter-frequency measurements more frequently than a device with no model, as the cost of predicting such measurements is far less than actually performing the measurements. In latency reduction (example 1 above), the network can omit building a predictor for the arrival of packets as this is already available at the device.

### Requesting Performance Measure From a Node That Previously Served the UE

The RAN node can in one example also receive information about what other nodes have served the UE, and which radio operations were based on ML when the wireless device was served by previous nodes. The RAN node can request performance measures for these radio network operations associated with one or more ML models. The performance measures provided by previous serving nodes are likely to be richer than the information that could be logged by UE, and the RAN node can use the performance measures to configure the UE radio network operations. In one example, the RAN node can configure the UE to not use ML models for one or more operations if the performance is below a threshold value.

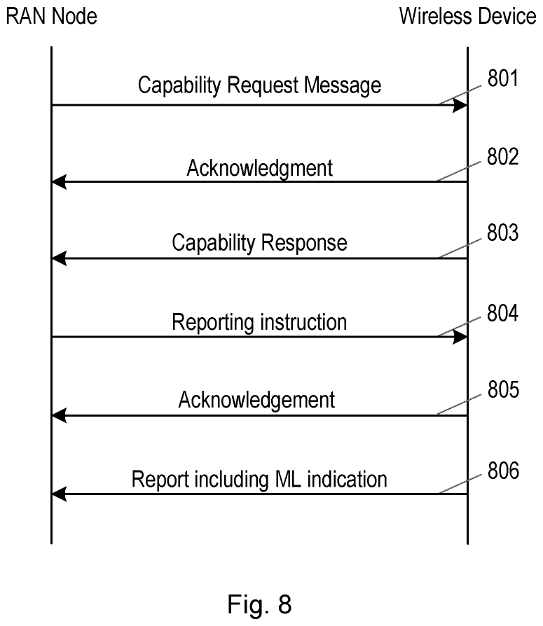

FIG. 8 is a signalling diagram illustrating another example signalling exchange that may take place during the performance of the methods 100, 200, 300 and/or 400. The signalling exchange of FIG. 8 is described below from the perspective of a wireless device, as opposed to the perspective of the RAN node discussed above for FIG. 7. However, consistent with the above description, it will be appreciated that the additional messages illustrated in FIG. 8 may also be exchanged in the context of the message exchange of FIG. 7.

Referring to FIG. 8, first step 801, a wireless device receives a request message from a RAN node requesting to report whether the wireless device is capable or configured to use ML models/algorithms. The wireless device sends an acknowledgement in step 802, which may be either of a positive acknowledgment (ACK) indicating that the wireless device is either capable or configured to use (or it is using) machine learning models and algorithms for its operation, or a negative acknowledgement (NACK) indicating that the wireless device either is not capable or not configured to use (or is not using) machine learning models and algorithms for its operation. In step 803, the wireless device transmits a response message indicating whether it is either capable or configured to use (or it is using) machine learning models and algorithms for its operation. The response message may include information such as what network node configured the ML model, when the model was received or trained, a performance measure associated to the model, and/or any of the information items discussed above with reference to FIGS. 2c and 7.

The wireless device may also receive from the RAN node a request to report to the RAN node which radio operations the wireless device executes with ML models/algorithms, and may transmit to the RAN node an indication of which radio operations the wireless device executes with ML models/algorithms. This request could be received as part of the request message received at step 801 or in a separate message. Similarly, the indication of which radio operations the wireless device executes with ML models/algorithms may be transmitted as part of the response message sent in step 803 or in a separate message.

In step 804, the wireless device may further receive a control message from the network node comprising an instruction for the wireless device to indicate, within at least a report message transmitted by the wireless device, whether and which information comprised in the report is generated with a ML model or algorithm. In response to the control message, the wireless device may transmit either a positive acknowledgement (ACK) or a negative acknowledgement (NACK) associated to the control message in step 805, wherein the ACK indicates that the wireless device can report the requested information and the NACK indicates that the wireless device cannot report the requested information to the network node. The wireless device may then transmit, to the RAN node, one or more reports in step 806, the reports associated with one or more operations of the wireless device and comprising an indication of whether and which information comprised in the report message is generated or determined using an ML model or algorithm.

In another example, the wireless device may further receive from the RAN node a request/instruction to indicate information about the machine learning models and algorithms used by the wireless device for one or more operations executed by the wireless device. The wireless device may respond by transmitting to the RAN node information about the machine learning models and algorithms used by the wireless device for one or more operation executed by the wireless device, as discussed in greater detail above.

As discussed in the present disclosure, the methods 100, 200 are performed by a RAN node, and the methods 300, 400 are performed by a wireless device, such as a UE. The present disclosure provides a RAN node and a wireless device that are adapted to perform any or all of the steps of the above discussed methods.

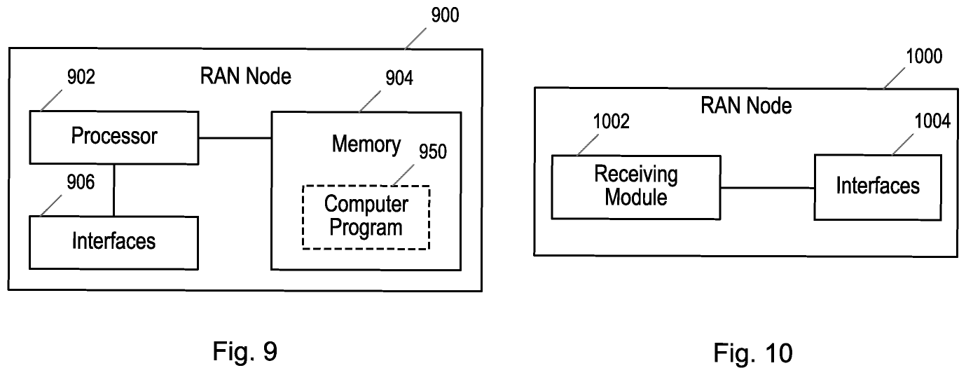

FIG. 9 is a block diagram illustrating an example RAN node 900 which may implement the method 100 and/or 200 according to examples of the present disclosure, for example on receipt of suitable instructions from a computer program 950. Referring to FIG. 9, the RAN node 900 comprises a processor or processing circuitry 902, and may comprise a memory 904 and interfaces 906. The processing circuitry 902 is operable to perform some or all of the steps of the method 100 and/or 200 as discussed above with reference to FIGS. 1 and 2a to 2c. The memory 904 may contain instructions executable by the processing circuitry 902 such that the RAN node 900 is operable to perform some or all of the steps of the method 100 and/or 200. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive etc.

FIG. 10 illustrates functional modules in another example of RAN node 1000 which may execute examples of the methods 100 and/or 200 of the present disclosure, for example according to computer readable instructions received from a computer program. It will be understood that the modules illustrated in FIG. 10 are functional modules, and may be realised in any appropriate combination of hardware and/or software. The modules may comprise one or more processors and may be integrated to any degree.

Referring to FIG. 10, the RAN node 1000 is for managing a wireless device that is operable to connect to the communication network of which the RAN node is a part. The RAN node comprises a receiving module 1002 for receiving, from the wireless device, information indicating whether the wireless device is capable of executing an ML model that is operable to provide an output on the basis of which at least one RAN operation performed by the wireless device may be configured. The RAN node may further comprise interfaces 1904.

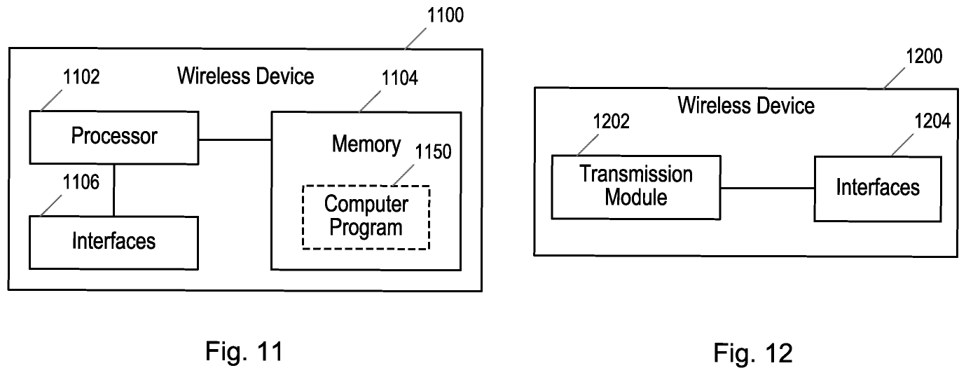

FIG. 11 is a block diagram illustrating an example wireless device 1100 which may implement the method 300 and/or 400 according to examples of the present disclosure, for example on receipt of suitable instructions from a computer program 1150. Referring to FIG. 11, the wireless devoice 1100 comprises a processor or processing circuitry 1102, and may comprise a memory 1104 and interfaces 1106. The processing circuitry 1102 is operable to perform some or all of the steps of the method 300 and/or 400 as discussed above with reference to FIGS. 3 and 4a and 4b. The memory 1104 may contain instructions executable by the processing circuitry 1102 such that the wireless devoice 1100 is operable to perform some or all of the steps of the method 300 and/or 400. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc.

FIG. 12 illustrates functional modules in another example of wireless devoice 1200 which may execute examples of the methods 300 and/or 400 of the present disclosure, for example according to computer readable instructions received from a computer program. It will be understood that the modules illustrated in FIG. 12 are functional modules, and may be realised in any appropriate combination of hardware and/or software. The modules may comprise one or more processors and may be integrated to any degree.

Referring to FIG. 12, the wireless device 1200 is operable to connect to a communication network, wherein the communication network comprises a RAN. The wireless device 1200 comprises a sending module 1202 for sending, to a RAN node of the communication network, information indicating whether the wireless device is capable of executing an ML model that is operable to provide an output on the basis of which at least one RAN operation performed by the wireless device may be configured.

The wireless device 1200 may further comprise interfaces 1204.

Aspects of the present disclosure, as demonstrated by the above discussion, provide methods, a RAN node and a wireless device that together may enable a RAN node to collect information about whether and which wireless devices under its coverage use ML models/algorithms to execute one or more of the wireless device operations within the radio network. When such operations produce reports for the radio network, it is beneficial for the network nodes to know how such reports have been produced by the wireless device. This allows a RAN node to distinguish between information reported by the wireless device based on radio measurements and information reported based on an ML model/algorithm. For example, if the wireless device report contains information about coverage estimated for a radio cell or a frequency band, it is beneficial to distinguish which wireless devices determine coverage based on measurements taken on reference signals and which wireless devices estimate coverage based on an ML model/algorithm.

Example methods, nodes and wireless devices according to the resent disclosure can improve the radio network operation in a range of different ways. For example, a network may be able to distinguish between information reported by the wireless device on the basis of radio measurements and information reported by the wireless device on the basis of ML models/algorithms. A network may also distinguish between wireless devices capable of executing ML models/algorithms and devices that are not capable of such execution, as well as identifying which operations of the wireless devices camping in the network are executed using ML models/algorithms. According to some examples, a network may be able to check whether a model is valid for current radio network environment conditions, and can update a model or models based on this information. Examples of the present disclosure may also improve energy efficiency of the network. For example, when a wireless device signals information about its ML model or models used for one or more radio network operations, it enables the relevant network node to reduce unnecessary signalling associated with retransmitting the same or similar model, as well as signalling reductions associated with exploiting the ML capabilities of the wireless device.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing a wireless device that is operable to connect to a communication network, wherein the communication network comprises a Radio Access Network, RAN, the method, performed by a RAN node of the communication network, comprising:
receiving, from the wireless device, information indicating whether the wireless device is capable of executing a Machine Learning, ML, model that is operable to provide an output on the basis of which at least one RAN operation performed by the wireless device may be configured.

2. The method as claimed in claim 1, wherein receiving, from the wireless device, information indicating whether the wireless device is capable of executing an ML model comprises receiving the information during a procedure performed by the wireless device for at least one of:
connection to the communication network;
mobility within the communication network.

3. The method as claimed in claim 1, further comprising receiving, from the wireless device, supplementary ML model information, the supplementary ML model information comprising at least one of:
information indicating whether the wireless device is or has been configured to execute an ML model that is operable to provide an output on the basis of which at least one RAN operation performed by the wireless device may be configured;
information indicating whether the wireless device is or has been performing a RAN operation that is configured on the basis of an output of an ML model executed by the wireless device;
an identification of a RAN operation performed by the wireless device and that the wireless device has configured, or is operable to configure, on the basis of an output of an ML model executed by the wireless device;
an identification, for a RAN operation, of an ML model that the wireless device is configured to execute and on the basis of which the RAN operation may be configured;
an identification of information reported by the wireless device that is based on an output of an ML model executed by the wireless device;
information about an ML model that the wireless device is or has been configured to execute, wherein the ML model is operable to provide an output on the basis of which at least one RAN operation performed by the wireless device may be configured;
information about a capability of the wireless device to execute an ML model.

4. (canceled)

5. The method as claimed in claim 1, further comprising:
sending a first request to the wireless device, the first request requesting information indicating whether the wireless device is capable of executing an ML model that is operable to provide an output on the basis of which at least one RAN operation performed by the wireless device may be configured; and
wherein receiving the information indicating whether the wireless device is capable of executing an ML model comprises receiving the information in a response to the first request.

6. The method as claimed in claim 5, further comprising receiving supplementary ML model information in response to the first request, the supplementary ML model information comprising at least one of:
information indicating whether the wireless device is or has been configured to execute an ML model that is operable to provide an output on the basis of which at least one RAN operation performed by the wireless device may be configured;
information indicating whether the wireless device is or has been performing a RAN operation that is configured on the basis of an output of an ML model executed by the wireless device;
an identification of a RAN operation performed by the wireless device and that the wireless device has configured, or is operable to configure, on the basis of an output of an ML model executed by the wireless device;
an identification, for a RAN operation, of an ML model that the wireless device is configured to execute and on the basis of which the RAN operation may be configured;
an identification of information reported by the wireless device that is based on an output of an ML model executed by the wireless device;
information about an ML model that the wireless device is or has been configured to execute, wherein the ML model is operable to provide an output on the basis of which at least one RAN operation performed by the wireless device may be configured;
information about a capability of the wireless device to execute an ML model.

7. The method as claimed in claim 5, further comprising:
sending a second request to the wireless device, the second request requesting supplementary ML model information from the wireless device; and
receiving the supplementary ML model information in response to the second request;
wherein the supplementary ML model information comprises at least one of:
information indicating whether the wireless device is or has been configured to execute an ML model that is operable to provide an output on the basis of which at least one RAN operation performed by the wireless device may be configured;
information indicating whether the wireless device is or has been performing a RAN operation that is configured on the basis of an output of an ML model executed by the wireless device;
an identification of a RAN operation performed by the wireless device and that the wireless device has configured, or is operable to configure, on the basis of an output of an ML model executed by the wireless device;
an identification, for a RAN operation, of an ML model that the wireless device is configured to execute and on the basis of which the RAN operation may be configured;
an identification of information reported by the wireless device that is based on an output of an ML model executed by the wireless device;
information about an ML model that the wireless device is or has been configured to execute, wherein the ML model is operable to provide an output on the basis of which at least one RAN operation performed by the wireless device may be configured;
information about a capability of the wireless device to execute an ML model.

8. The method as claimed in claim 7, wherein the second request comprises a list of RAN operations that may be performed by the wireless device, and an instruction to confirm which of the listed RAN operations the wireless device is performing, or has been configured to perform, on the basis of the output an output of an ML model executed by the wireless device.

9. (canceled)

10. The method as claimed in claim 1, further comprising instructing the wireless device, when reporting information, to identify information reported by the wireless device that is based on an output of an ML model executed by the wireless device.

11-13. (canceled)

14. The method as claimed in claim 1, further comprising:
configuring a parameter of a RAN operation to be executed by the wireless device on the basis of the received information.

15. (canceled)

16. A method for managing a wireless device that is operable to connect to a communication network, wherein the communication network comprises a Radio Access Network, RAN, the method, performed by the wireless device, comprising:
sending, to a RAN node of the communication network, information indicating whether the wireless device is capable of executing a Machine Learning, ML, model that is operable to provide an output on the basis of which at least one RAN operation performed by the wireless device may be configured.

17. The method as claimed in claim 16, wherein sending, to the RAN node of the communication network, information indicating whether the wireless device is capable of executing an ML model comprises sending the information during a procedure performed by the wireless device for at least one of:
connection to the communication network;
mobility within the communication network.

18. The method as claimed in claim 16, further comprising, sending to the RAN node of the communication network supplementary ML model information, the supplementary ML model information comprising at least one of:
information indicating whether the wireless device is or has been configured to execute an ML model that is operable to provide an output on the basis of which at least one RAN operation performed by the wireless device may be configured;
information indicating whether the wireless device is or has been performing a RAN operation that is configured on the basis of an output of an ML model executed by the wireless device;
an identification of a RAN operation performed by the wireless device and that the wireless device has configured, or is operable to configure, on the basis of an output of an ML model executed by the wireless device;
an identification, for a RAN operation, of an ML model that the wireless device is configured to execute and on the basis of which the RAN operation may be configured;
an identification of information reported by the wireless device that is based on an output of an ML model executed by the wireless device;
information about an ML model that the wireless device is or has been configured to execute, wherein the ML model is operable to provide an output on the basis of which at least one RAN operation performed by the wireless device may be configured;
information about a capability of the wireless device to execute an ML model.

19. (canceled)

20. The method as claimed in claim 16, further comprising receiving a first request from the RAN node of the communication network, the first request requesting information indicating whether the wireless device is capable of executing an ML model that is operable to provide an output on the basis of which at least one RAN operation performed by the wireless device may be configured; and
wherein sending the information indicating whether the wireless device is capable of executing an ML model comprises sending the information in a response to the first request.

21. (canceled)

22. The method as claimed in claim 20, further comprising:
receiving a second request from the RAN node of the communication network, the second request requesting supplementary ML model information from the wireless device; and
sending the supplementary ML model information to the RAN node of the communication network in response to the second request;
wherein the supplementary ML model information comprises at least one of:
information indicating whether the wireless device is or has been configured to execute an ML model that is operable to provide an output on the basis of which at least one RAN operation performed by the wireless device may be configured;
information indicating whether the wireless device is or has been performing a RAN operation that is configured on the basis of an output of an ML model executed by the wireless device;
an identification of a RAN operation performed by the wireless device and that the wireless device has configured, or is operable to configure, on the basis of an output of an ML model executed by the wireless device;
an identification, for a RAN operation, of an ML model that the wireless device is configured to execute and on the basis of which the RAN operation may be configured;
an identification of information reported by the wireless device that is based on an output of an ML model executed by the wireless device;
information about an ML model that the wireless device is or has been configured to execute, wherein the ML model is operable to provide an output on the basis of which at least one RAN operation performed by the wireless device may be configured;
information about a capability of the wireless device to execute an ML model.

23. The method as claimed in claim 22, wherein the second request comprises a list of RAN operations that may be performed by the wireless device, and an instruction to confirm which of the listed RAN operations the wireless device is performing, or has been configured to perform, on the basis of the output an output of an ML model executed by the wireless device.

24. (canceled)

25. The method as claimed in claim 16, further comprising receiving from the RAN node of the communication network an instruction, when reporting information, to identify information reported by the wireless device that is based on an output of an ML model executed by the wireless device.

26. (canceled)

27. (canceled)

28. The method as claimed in claim 16, further comprising:
receiving, from the RAN node of the communication network, information about the updated ML model for execution by the wireless device.

29. The method as claimed in claim 16, further comprising:
receiving, from the RAN node of the communication network, configuration information for a parameter of a RAN operation to be executed by the wireless device wherein the configuration information is based on the information sent by the wireless device to the RAN node of the communication network.

30. (canceled)

31. A Radio Access Network, RAN, node of a communication network comprising a RAN, wherein the RAN node is for managing a wireless device that is operable to connect to the communication network, and wherein the RAN node comprises processing circuitry configured to cause the RAN node to:
receive, from the wireless device, information indicating whether the wireless device is capable of executing a Machine Learning, ML, model that is operable to provide an output on the basis of which at least one RAN operation performed by the wireless device may be configured.

32. (canceled)

33. A wireless device that is operable to connect to a communication network, wherein the communication network comprises a Radio Access Network, RAN, the wireless device comprising processing circuitry configured to cause the wireless device to:
send, to a RAN node of the communication network, information indicating whether the wireless device is capable of executing a Machine Learning, ML, model that is operable to provide an output on the basis of which at least one RAN operation performed by the wireless device may be configured.

34. (canceled)
